(19) United States
(12) Patent Application Publication
(10) Pub. No.: US 2004/0107358 A1
(43) Pub. Date: Jun. 3, 2004

(54) [DataVault X4 Multi-Network Secure Computer]

(75) Inventor: Peter Paul Shiakallis, Chesapeake, VA (US)

Correspondence Address: JAMES F. CHRISTIAN, JR., 4144 STONE BRIDGE LANDING, CHESAPEAKE, VA, 23321, US

(73) Assignee: Peter Paul Shiakallis, Chesapeake, VA (US)

(21) Appl. No.: 10/605,391

(22) Filed: Sep. 26, 2003

(51) Int. Cl. H04L 9/32

(52) U.S. Cl. 713/200

(57) ABSTRACT

This system is a dual computer system with two or more separate network domains built in a custom secure computer case with lockable front and back covers, incorporating two totally separate (CPU), motherboards, (RAM), hard drives, floppy drives, (CD-ROM) drives, a secure removable hard drive, an electromechanical key-lock/switch for power-on and access control, two separate color coded reset buttons, a Smart Card® reader/writer which will verify the user identity through an entered (PIN) for accessing the classified network domain and an external electronic switch for switching video, keyboard, mouse signals for each network domain. Upon powering up the computer with the secured access control key the computer will power-up both secure domains however, only the first secure domain will be accessible. The classified domain can be accessed within one second where a (PIN) will be required through the Smart Card® reader/writer for user access control which guarantees user access control.

### BACKGROUND OF INVENTION

This invention relates to a multilevel network secure computer system built within a custom secure case which is comprised of two or more hardware domains that are active concurrently. This system can switch between the classified and unclassified domains instantly and control user access to the computer itself and the secure network without powering down one domain and then re-booting and powering up to the second or third domain. Subsequently this results in no data loss and no switching delays. The final result is instant viewing of classified or unclassified data in one computer case without any chance of data being compromised. This is achieved using hardware-based technology and without any shared devices within the system. The case and the power supply are the only shared devices.

### SUMMARY OF INVENTION

Prior design of multilevel computer systems include the use of complicated mechanical switching mechanisms (U.S. Pat. No. 6,009,518) or the addition of complex circuitry with relays and microprocessors controlled via automatic teller machine (ATM) styled keypads requiring a personal identification number (PIN) for switching from one network domain to the other by powering down one domain and powering up to another domain. (U.S. Pat. Nos. 6,389,542,/6,351,810) These systems result in total loss of data between one domain to the other during switchover which includes operating system shutdown and re-booting along with substantial switching time delays. Most of such computer systems share the same central processing units (CPU), random access memory (RAM), universal serial bus (USB) controllers, video memory, floppy drives, and compact disk read only memory (CD-ROM) drives. They also use commonly available Smart Card® readers/writer technology for additional user access control.

The objective of this invention is to provide a custom-built secure multilevel computer system to provide data security from within and prevent inside unauthorized user access as well as outside unauthorized user access via the Internet or a network. This invention was requested by the Department of Defense, the Pentagon and other government agencies to be used in critical operating environments for secured and unsecured networks that need to be viewed without delays. These environments require processing of unclassified and classified data instantly and without compromising data security between domains and without powering down and re-booting between domains which results to data loss upon switching between domains contained in the same computer.

The benefits of this technology other than data security include; instant domain switching, reduced footprint, reduced power consumption, reduced heat output, reduced EMF emissions, reduced maintenance and acquisition costs, and reduced operating system costs.

### BRIEF DESCRIPTION OF DRAWINGS

FIG. 1 is a block diagram of the DataVault X4 Multi-Network Computer.

FIG. 2 is the rear view of the DataVault X4 Multi-Network Computer.

FIG. 3 is the front view of the DataVault X4 Multi-Network Computer.

### DETAILED DESCRIPTION

By implementing a physical hardware access control of the specially constructed computer case itself via a hardware lock/key cover for the front of the computer case as well as the back, ensures a solid access control to the physical hardware itself before the computer can be turned on via an electromechanical key lock which is similar to the ignition key of a vehicle.

Each hardware domain within the specially constructed cast iron computer case has its own CPU, memory, motherboard, network card, video card, sound card, hard drive, floppy drive, parallel and serial ports, USB, CD-ROM drive and separate color-coded reset buttons, (red and green) on the front side of the computer case. The red button indicates the secured domain hardware reset and the green indicates the unsecured domain hardware reset. Each hardware domain can be re-booted and restarted independently without affecting the other domain, during software installations. The Smart Card® reader/writer is connected only on the secured hardware domain which provides access to authorized users only. A third optional hardware domain can be controlled through the same access control method using the Smart Card® reader/writer.

Upon powering-on the computer using the physical key in the lock which is in the front of the computer case, both hardware domains activate and access to the unsecured domain is available by default. The unsecured domain is defined by its own memory device or hard drive for storing data which by definition is a domain level with unrestricted access. The first domain level with unrestricted access may further have a modem device for telecommunication for internet access as well as a network card for unsecured network access. The unsecured domain also has its own independent read-only memory device such as CD-ROM and a floppy disk drive labeled with a green dot for easy identification.

By pressing the red button on the electronic KVM (keyboard/video/mouse) switch, access to the second domain level is restricted by the Smart Card® reader/writer. The authorized user must then insert his own personal ID card into the Smart Card® reader/writer for access and user identification and authentication by entering his PIN (personal identification number or password). Once a PIN number is entered, the authorized user can proceed and access the secured domain or classified network. At any time the authorized user wishes to switch to the unsecured domain network, he or she can do so by pressing the unsecured button on the KVM switch and instantly access the internet or unsecured network without having to shut down the secured domain and re-boot the unsecured domain. The authorized user can switch back to the secure domain by pressing the secured button on the KVM switch within less than a second without re-powering or re-booting domains and without a loss of data on either domains.

The secured domain is also defined by its own memory device and a removable hard drive case with a lock key, for storing data, which by definition is a domain level with restricted access. The secured domain also has its own independent read-only memory device such as compact disk CD-ROM and a floppy disk labeled with a red dot for easy identification. When the secured domain authorized user completes his or her assignment, they can then perform normal system shutdown and remove the secured domain's hard drive without affecting the operation of the unsecured domain.

In order to ensure that data may not bleed-over from the unsecured domain and network to the secured domain and network within the case, the motherboards and network devices were placed with three inches apart and were separated with a special microwave aluminum shield. This shield assures the integrity of data access control, data storage, and data communications for both the secure and unsecured sides of the computer will remain in tact emphasizing that top level security will be maintained for classified network activities.

The physical back cover key/lock prevents unauthorized users from manipulating network cables between the secured and unsecured domains as well as preventing removal of other devices such as video/keyboard/mouse cables.

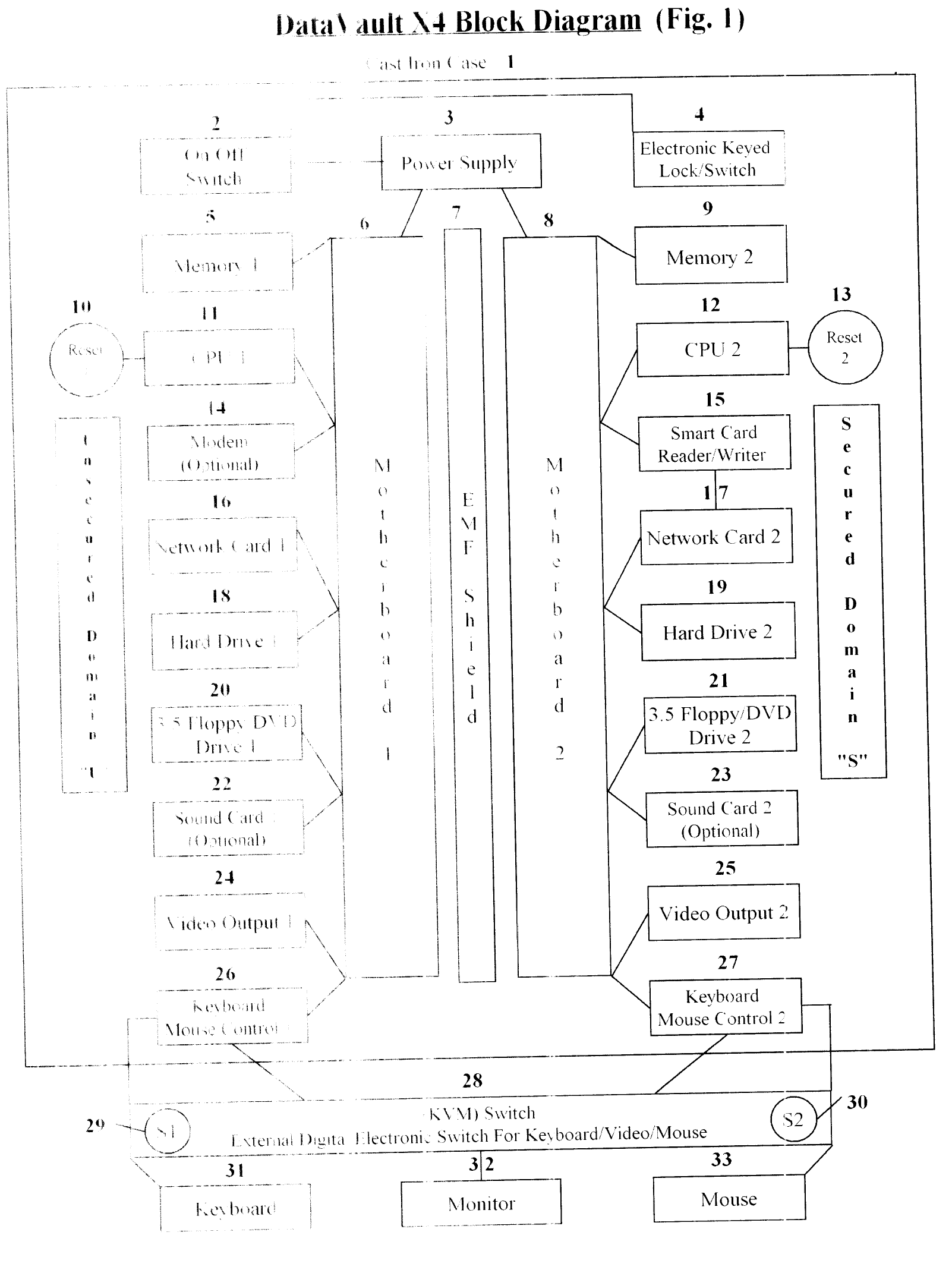

The DataVault X4 offers a solid hardware based security solution that securely processes and stores unclassified and classified data without requiring two separate computers to achieve this effect. The Data Vault X4 incorporates a non-software dependent electromechanical key-lock that requires a high level security key to activate it, and this key cannot be removed while in operation nor can it be duplicated. The removable classified hard drive on the secured domain requires a key for removal since classified hard drives must be placed in a safe when not in use. The second layer of security for the classified domain is implemented through the built-in dedicated Smart Card® reader/writer that provides access control and user identification and authentication. The DataVault X4 has the security functionality of up to three separate computers in a single cost-effective workstation. A single DataVault X4 requires only one software license, monitor, keyboard and mouse and dramatically reduces heat output, power consumption and space requirements by at least one half, along with significantly reducing maintenance, life-cycle and repair costs of the multiple computers that it could replace. DATAVAULT X4 COMPONENTS (FIG. 1) The DataVault X4 is built in a heavy-duty cast iron computer case (1) especially designed to accommodate 14 expansion slots instead of the traditional 6 or 8. The case has a low EMF radiation output level and a 350 watt power supply, (3) one electronic on/off switch (2) and one hardware access control electronic/mechanical keyed switch (4) for identification/authentication. Within the case are two completely isolated and independent domains, one unsecured (Designated “U”) for general use and one secure (Designated “S”) each with an isolated reset button (10 & 13) respectively. Both domains operate and are active concurrently. Each domain contains two isolated memory banks (5 & 9), two isolated CPU (11 & 12), two isolated hard drives (18 & 19 where the secure hard drive is removable), two isolated network cards (NIC), (16 & 17), two isolated video cards (24 & 25), two isolated 3.5 inch Floppy/DVD CD-ROM combo drives (20 & 21), and two isolated keyboard/mouse controllers. (26 & 27) Each of these pairs of components are on the respective secure and unsecured sides of the computer. The unsecured side of the computer also has an optional modem feature (25) and both sides of the computer have optional sound card features. (22 & 23)The secure side of the computer incorporates a Smart Card® reader/writer (15) for an additional layer of security for user access and identification/authentication. An EMF shield (7) separates the unsecured side from the secure side of the computer so data bleed-over does not otherwise compromise data integrity and security. One external digital electronic switch (28) operates the swapping of a single keyboard (31), single video monitor (32), and single mouse (33) from the unsecured to the secure domain. Each interchange from one domain to the other takes place in approximately one second using buttons S1 and S2 (29 & 30) respectively. No system-wide reset or shutdown is necessary when switching domains. Both domains remain active with no data loss taking place on either domain when switching to the other respective domain and back again on demand by the authorized user and without delay for rebooting.

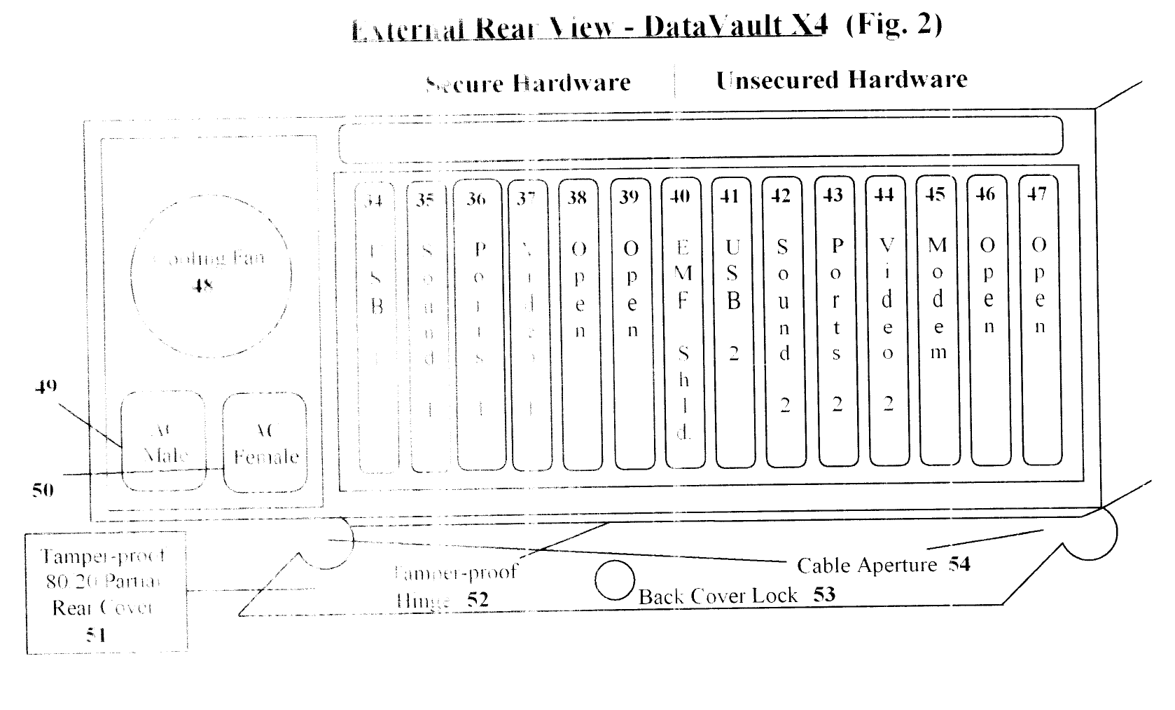

External Rear View Datavault X4 (FIG. 2)

The DataVault X4 has 14 slots across the rear of the case. Slots 34 through 39 reside on the secure side of the computer. From left to right they range from a USB card, optional sound card, a combination COM/LPT port card, video card and two open slots respectively. Separating the secure side from the unsecured side of the computer is an EMF radiation shield that physically separates the two domains and motherboards respectively. (40) Slots 41 through 47 reside on the unsecured side of the computer. From left to right they range from a USB card, optional sound card, a combination COM/LPT port card, video card, optional modem and two open slots respectively.

A cooling fan (48) and two AC connections are on the left rear side of the case. One male AC connection (49) for connecting the computer power supply to 110 volt electrical current and one female AC connection (50) for supplying 110 volt current to a monitor. A locking (53) tamper-proof rear cover (51) with apertures (54) for cables to exit respective opposite directions of the secure and unsecured sides of the computer insure cables can not be switched and therefore maintain data integrity for the two separate networks.

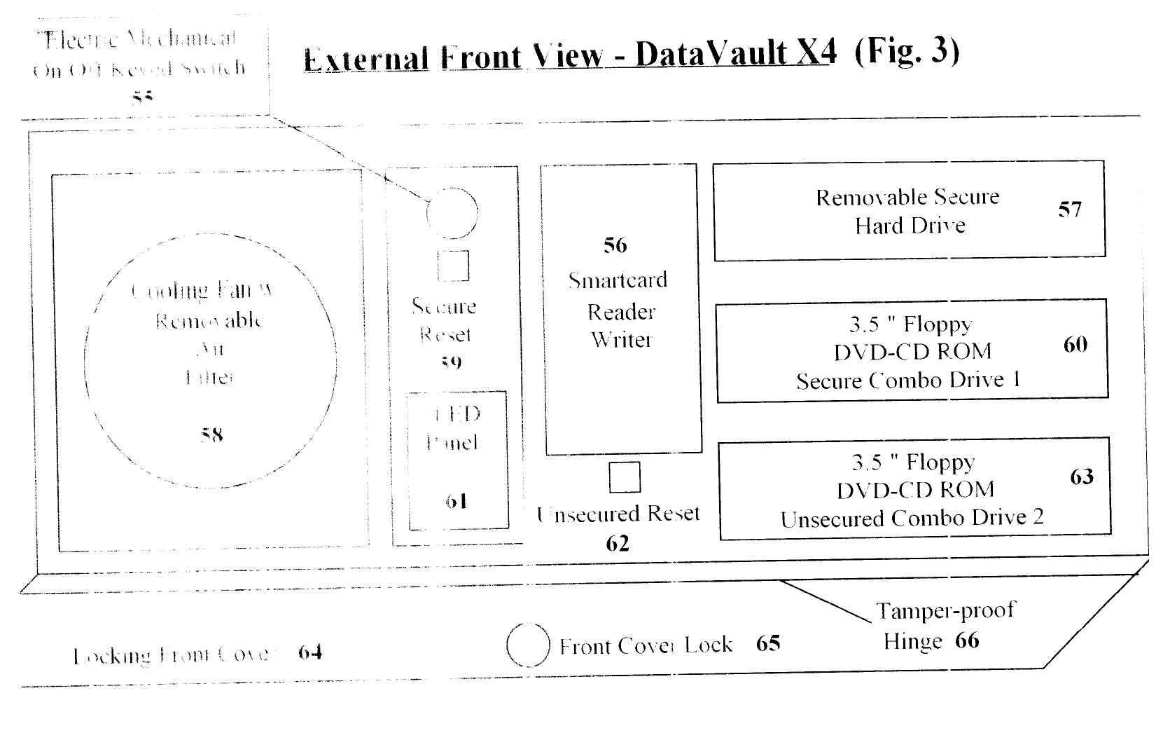

External Front View Datavault X4 (FIG. 3)

The DataVault X4 is first accessed by inserting a physical key in a mechanical keyed lock (FIG. 65) on the front cover (64) mounted on a tamper-proof metal hinge. (66) An electromechanical lock on the front of the computer requires a physical high-level key to first turn-on (55) the computer and boots both domains of the computer up simultaneously. The unsecured side is accessible immediately upon booting by default and so is the domain and network. To access the secure side of the computer the red button is pressed on the KVM (keyboard/video/mouse) electronic switch (59) which prompts the authorized user to insert a Smart Card® into the Smart Card® reader/writer (56) and a PIN number is requested. Authorization is granted upon entering the correct PIN code. To move back to the unsecured domain, the green button (62) on the KVM electronic switch is pushed and immediate switching occurs to the unsecured domain without reset or re-booting and without data loss.

A removable secure hard drive (57) with a built-in key/lock allows removal for safe storage when the computer is not in use, which is located above the two secure and unsecured 3.5 DVD-CD ROM combo drives respectively. (60 63) A cooling fan with replaceable air filters (58) adds cooling power to the power supply needed for running the dual or triple motherboards and an LED panel (61) keeps the user abreast of vital information while at operation of the DataVault X4.

What is claimed is:

1. A multilevel custom secured computer system comprising:
A custom-built computer case with lockable front and back covers using high-level security key/locks, and fourteen (14) hardware slots within the case, two separate motherboards with their own independent central processor units (CPU), random access memory (RAM), video card, network interface card (NIC) within each domain, two separate hard drives (one within a removable hard drive case), two separate floppy disk(s) and CD-ROM(s) drive(s), and a keyboard, video, mouse, (KVM) switch for switching keyboard, video and mouse functions between the two separate domains;
The first computer domain within this custom-built case is identified as the UNSECURED DOMAIN, having an optional fax/modem which allows data communications via the Internet, and the ability to operate independently with its own central processing unit (CPU), network interface card (NIC) for connecting to an unsecured network, video card, hard drive, floppy/CD-ROM drive(s) labeled with a green mark for easy identification, operating system (OS), and random access memory (RAM);
The second computer domain within this custom-built case is identified as the SECURED DOMAIN, having a Smart Card® reader/writer that reads and process access requests and provides identification and authentication for authorized users having a Smart Card® reader/writer token, and the ability to operate independently with its own central processing unit (CPU), network interface card (NIC) for connecting to a secured network, video card, removable hard drive with a lock/key, (for storing secured data and is removable to be stored in a safe after each use) floppy/CD-ROM drive(s) labeled with a red mark for easy identification, operating system (OS), and random access memory (RAM);
An electromechanical lock/key on the front of the case for powering-on both computer domains and cannot be removed unless the system is powered off;
A green reset button in the front of the computer case which provides the reset function for the unsecured domain;
A red reset button in the front of the computer case which provides the reset function for the secured domain;

2. The multileveled custom secured computer system as set forth in claim 1, with said first computer domain including a central processing unit (CPU), random access memory (RAM), hard disk drive, floppy/CD-ROM drives, network interface card, random access memory, video card, sound card and optional modem.

3. The multileveled custom secured computer system as set forth in claim 1, with the second computer domain including a central processing unit (CPU), random access memory (RAM), removable hard disk drive, floppy/CD-ROM drives, network interface card, random access memory, video card, optional sound card, Smart Card® reader/writer for user access control and identification and authentication.

4. A lockable front cover as set forth in claim 1 provides a hardware-based access control to the multileveled custom secured computer case using a high-level security lock/key.

5. A lockable back cover as set forth in claim 1, with two separate cable outputs which allows color-coded network cables to remain separate and identified, a high-level mechanical lock/key for preventing cable interchange or removal.

6. An electromechanical high-level security lock/key which is connected to the ON/OFF function of the main computer case power supply will activate and power-on both computer domains when the authorized user inserts the high-level security key. The key of said electromechanical high-level security lock must be inserted and turn clockwise to the ON position by the authorized user first. The unsecured domain will be accessible first by default without any other access control requirement. It is impossible to turn-on the multileveled custom secured computer without the key. The key cannot be removed in the ON position. It can only be removed in the OFF position, when both, the secured and unsecured domains are no longer in use and the user has shut down their respective operating systems (OS).

7. A custom-built Y power cable from the computer case power supply provides power to both domains or central processing units or motherboards, the unsecured domain and the secured domain.

8. An aluminum-based electromagnetic field (EMF) shield is placed between the two central processing units (CPU) or motherboards within the case, to prevent data-bleed over between the two domains and networks.

9. The Smart Card® reader/writer as set forth in claim 1 is interfaced and connected only with the secured domain's central processing unit (CPU) or motherboard and provides access control and user authentication and identification ensuring data integrity for the classified data on the removable hard disk drive and network for the secured domain.

10. An external digital electronic switch otherwise described as keyboard, video, mouse or (KVM), which is connected directly to both domains, the unsecured and secured, provides instant switching between the two domains without having to shut down the operating systems or loose data on either domain. Two light emitting diodes (LED) on the keyboard, video, mouse, (KVM) switch, one green and the other red, indicate which domain the authorized computer user is operating.

11. The unsecured domain is ON by default upon powering up the multilevel custom secured computer system when the authorized user inserts his high-level security key into the electromechanical lock of the front panel of the computer case. On this mode access to the secured domain is not possible.

12. The secured domain can be selected by pressing the red button on the (KVM) switch and access will be allowed only through the use of the Smart Card® reader/writer that will require the authorized user to insert his Smart Card® and subsequently his personal identification number (PIN). Without the use of the authorized user's Smart Card®, it is impossible to access the secured domain removable hard disk drive and secured network.

13. The multi-level custom secured computer system as set forth in claim 6 is mechanically activated with the use of the high-level security key which interfaces with the computer case power supply by sending an activation signal to power-on both domains concurrently. However, only one domain is operational and accessible at a time.

14. The multi-level custom secured computer system provides high assurance data access control and secured data processing, data storage, and data communications for data at the unsecured domain and data at the secured domain, all within a custom-built high-security computer case. Both, the unsecured domain and the secured domains having their own totally independent (CPU), data storage devices such as hard disk drives, floppy/CD-ROM drives, memory, video, network interface cards, operating systems (OS), are totally isolated and independent and operate simultaneously without allowing data to inadvertently cross over between domains.

15. The secured domain's removable hard drive as set forth in claim 12 incorporates its own hardware-based locking mechanism with a key for removal and storage after each use. The key cannot be removed while the secured domain and hard drive is operational. It can only be removed when the system is powered off on both domains.

16. The two separate domains as set forth in claim 1 require sufficient cooling due the extra internal components that produce heat. A second cooling fan was installed in the front of the multi-level custom secured computer system which includes a reusable air filter in order to have adequate air circulation within the system.

17. The two separate domains as set forth in claim 1 incorporate two floppy/CD-ROM combo drives each, which are installed into two separate 5¼″ drive bays. One floppy/CD-ROM combo which is installed into one 5¼″ drive bay is connected directly to the unsecured motherboard/CPU and can only process data and information for the unsecured domain. A green indicator identifies this floppy/CD-ROM drive for the unsecured domain.

18. The secured domain's floppy/CD-ROM combo as set forth in claim 17 is installed into a separate 5¼″ drive bay and is connected directly to the secured motherboard/CPU and can only process data and information for the secured domain. A red indicator identifies this floppy/CD-ROM drive for the secured domain.

19. The unsecured domain's floppy/CD-ROM combo as set forth in claim 17 is installed into a separate 5¼″ drive bay and is connected directly to the unsecured motherboard/CPU and can only process data and information for the unsecured domain. A green indicator identifies this floppy/CD-ROM drive for the unsecured domain.
